(19) United States
(12) Patent Application Publication
(10) Pub. No.: US 2026/0119857 A1
(43) Pub. Date: Apr. 30, 2026

(54) METHOD FOR DYNAMIC QUANTIZATION OF NEURAL NETWORKS

(71) Applicant: Kinara, Inc., Santa Clara, CA (US)

(72) Inventors: Mohamed Shahim, Hyderabad (IN); Jayant Lingamaneni, Hyderabad (IN); Siddharth Kolipara, Hyderabad (IN); Gundimeda Durga Sai Krishna, Hyderabad (IN); Attaluri Lohit Siva Saketh, Hyderabad (IN); Oruganti Bala Gopal, Hyderabad (IN); Mohammad Zakee Hungund, Dharwad (IN); Rajashekar Reddy Ereddy, Hyderabad (IN); Wajahat Qadeer, Campbell, CA (US); Rehan Hameed, Palo Alto, CA (US)

(21) Appl. No.: 19/376,210

(22) Filed: Oct. 31, 2025

Related U.S. Application Data
(60) Provisional application No. 63/714,616, filed on Oct. 31, 2024.

(51) Int. Cl. G06N 3/0495; G06F 17/18

(52) U.S. Cl. CPC G06N 3/0495; G06F 17/18

(57) ABSTRACT

A method for dynamic quantization of a model includes: accessing a floating-point output activation of an operation and characterized by a tensor including a set of floating-point elements; and segmenting the tensor into a set of subtensors, each subtensor characterized by a quantity of elements corresponding to a group size assigned to the operation and including a subset of floating-point elements. The method also includes, for each subtensor: calculating a dynamic range of the subset of floating-point elements; calculating a local scale for the subset of floating-point elements based on the dynamic range; and converting the subset of floating-point elements into a subset of reduced-precision elements, in a first set of reduced-precision elements, characterized by the local scale. The method further includes: generating a reduced-precision output activation characterized by the first set of reduced-precision elements.

### CROSS-REFERENCE TO RELATED APPLICATIONS

This Application claims the benefit of U.S. Provisional Application No. 63/714,616, filed on 31, Oct. 2024, which is incorporated in its entirety by this reference.

This Application is related to U.S. patent application Ser. No. 17/112,889, filed on 04, Dec. 2020, which is incorporated in its entirety by this reference.

### TECHNICAL FIELD

This invention relates generally to the field of neural networks and, more specifically, to a new and useful method for dynamic quantization of neural networks within the field of neural networks.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method;

FIG. 4 is a flowchart representation of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

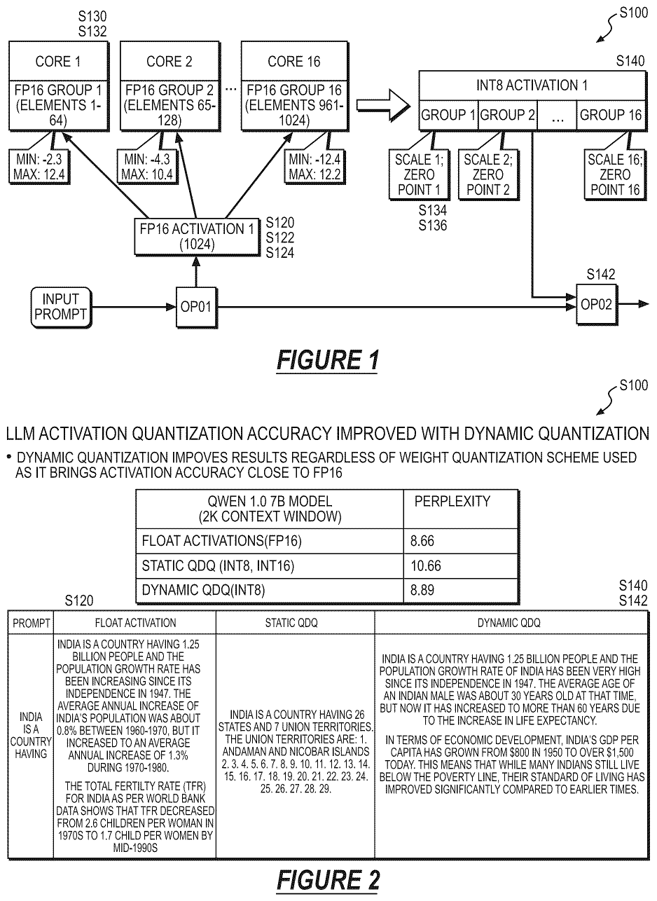

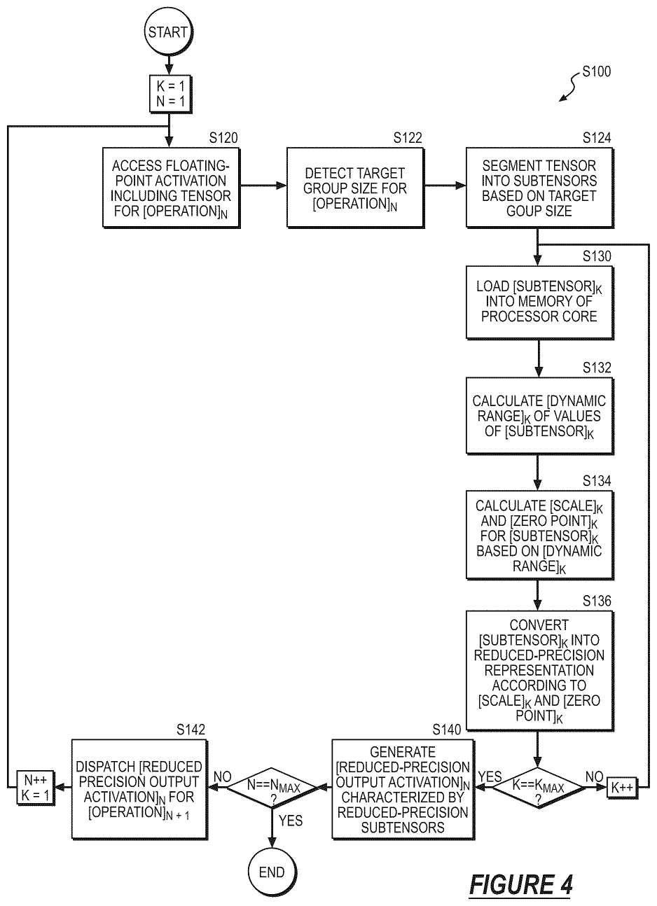

As shown in FIGS. 1 and 4, a method S100 for dynamic quantization of a model includes, during execution of the model at a set of processor cores: for a first operation in a set of operations of the model: accessing a first floating-point output activation representing a first output of the first operation and characterized by a first tensor including a first set of floating-point elements in Block S120; detecting a first group size and a first reduced-precision representation assigned to the first operation in Block S122; and segmenting the first tensor into a first set of subtensors including a first subtensor in Block S124. Each subtensor in the first set of subtensors is characterized by a quantity of elements corresponding to the first group size. The first subtensor includes a first subset of floating-point elements in the first set of floating-point elements.

The method S100 also includes, by a first processor core in the set of processor cores: calculating a first set of statistics based on the first subset of floating-point elements in Block S132; calculating a first scale for the first subset of floating-point elements based on the first set of statistics in Block S134; and converting the first subset of floating-point elements into a first subset of reduced-precision elements, in a first set of reduced-precision elements, characterized by the first reduced-precision representation according to the first scale in Block S136.

The method S100 further includes generating a first reduced-precision output activation representing the first output of the first operation based on the first set of reduced-precision elements in Block S140.

### 1.1 Variation: Processor Core Local Memory

As shown in FIGS. 1 and 4, one variation of the method S100 includes, during execution of a model at a set of processor cores: for a first operation in a set of operations of the model: accessing a first floating-point output activation representing a first output of the first operation and characterized by a first tensor comprising a first set of floating-point elements in Block S120; detecting a first group size and a first reduced-precision representation assigned to the first operation in Block S122; and segmenting the first tensor into a first set of subtensors in Block S124. Each subtensor in the first set of subtensors: is characterized by a quantity of elements corresponding to the first group size; and includes a subset of floating-point elements in the first set of floating-point elements.

This variation of the method S100 also includes, for each subtensor in the first set of subtensors, at a processor core in the set of processor cores: loading the subset of floating-point elements of the subtensor completely within local memory in the processor core in Block S130; calculating a set of statistics based on the subset of floating-point elements in the subtensor in Block S132; calculating a scale for the subset of floating-point elements based on the set of statistics in Block S134; and converting the subset of floating-point elements into a subset of reduced-precision elements, in a first set of reduced-precision elements, characterized by the first reduced-precision representation according to the scale in Block S136.

This variation of the method S100 further includes, in Block S140, generating a first reduced-precision output activation: representing the first output of the first operation; and characterized by the first set of reduced-precision elements.

### 1.2 Variation: Large Language Model

As shown in FIGS. 1 and 4, one variation of the method S100 includes, during execution of a large language model at a set of processor cores: for a first operation in a set of operations of the large language model: accessing a first floating-point output activation representing a first output of the first operation and characterized by a first tensor including a first set of floating-point elements in Block S120; and segmenting the first tensor into a first set of subtensors based on a first group size assigned to the first operation in Block S124. Each subtensor in the first set of subtensors: is characterized by a quantity of elements corresponding to the first group size; and includes a subset of floating-point elements in the first set of floating-point elements.

This variation of the method S100 also includes, for each subtensor in the first set of subtensors, at a processor core in the set of processor cores: loading the subset of floating-point elements of the subtensor completely within local memory in the processor core in Block S130; calculating a dynamic range of the subset of floating-point elements in Block S132; calculating a local scale and a local zero point for the subset of floating-point elements based on the dynamic range in Block S134; and converting the subset of floating-point elements into a subset of reduced-precision elements, in a first set of reduced-precision elements, characterized by a fixed-point representation according to the local scale and the local zero point in Block S136.

This variation of the method S100 further includes: generating a first reduced-precision output activation representing the first output of the first operation and characterized by the first set of reduced-precision elements in Block S140; and dispatching the first reduced-precision output activation as an input for a second operation in the set of operations in Block S142.

### 2. Applications

Generally, a computer system (hereinafter “the system”) can execute Blocks of the method S100 to dynamically quantize output activations of a model (e.g., a neural network, a large language model, a generative pre-trained transformer) from a floating-point representation (e.g., a sixteen-bit floating-point representation) into a reduced-precision representation (e.g., an eight-bit integer representation) during execution of the model in order to: reduce power consumption during execution of the model; and/or reduce a hardware area (e.g., an arithmetic logic unit configuration, a memory footprint) allocated to execution of the model. Therefore, the system can execute Blocks of the method S100 to enable (or improve) execution of the model on a resource-constrained device, such as an edge device characterized by limited computational capacity, limited memory, and/or limited power capacity.

More specifically, the system can execute Blocks of the method S100: to access a tensor (e.g., including 1,024 elements) representing an intermediate output of a model layer and including a set of floating-point elements; to segment the tensor into subtensors characterized by subsets of floating-point elements according to a group size (e.g., 64 elements, 128 elements); to load each subtensor completely into local memory of a processor core (e.g., a neural network processing unit); to calculate statistics (e.g., a dynamic range of values) for each subtensor based on a subset of floating-point elements in the subtensor; to calculate a local scale—such as a local scale characterized by a power of two—and a local zero point for each subtensor based on these statistics; and to convert (or “quantize”) each subtensor from the floating-point representation into the reduced-precision representation according to the scale and the zero point for the subtensor.

Therefore, rather than calculating a dynamic range of the entire set of floating-point elements in the tensor (which may exceed a memory capacity of a processor core and/or exhibit high variability due to presence of outlier elements), the system can execute Blocks of the method S100: to partition the set of floating-point elements into groups of floating-point elements; to load each group of floating-point elements completely within local memory of a processor core; to calculate a local dynamic range and a local scale for each group of floating-point elements; and to convert each group of floating-point elements into a group of reduced-precision elements based on the local scale in order to reduce accuracy loss due to presence of outlier elements during quantization of floating-point elements to reduced-precision elements and/or bypass memory operations between local memory of the processor core and shared memory during calculation of a dynamic range of floating-point elements, thereby increasing execution speed (e.g., token rate) of the model on the resource-constrained device.

Additionally, by calculating the local scale characterized as a power of two, the system can quantize the subset of floating-point elements into the subset of reduced-precision elements (or dequantize the subset of reduced-precision elements into a set of floating-point elements) by executing bit shift operations—rather than division (or multiplication) operations—in order to simplify and/or accelerate computation for the resource-constrained device.

### 2.1 Example: Large Language Model

In one example, the system executes Blocks of the method S100: to access a large language model including a set of layers; to access a set of input data (e.g., a set of input tokens) for the large language model; and to generate a first output activation including a set of floating-point elements (e.g., 1,024 elements in sixteen-bit floating-point representation) in response to execution of a first layer according to the set of input data via a processor.

In this example, the system executes Blocks of the method S100: to segment the set of floating-point elements into groups of floating-point elements (e.g., sixteen groups); to load a first group of 64 elements into local memory of a first processor core of the processor; to calculate a first dynamic range of the first group of 64 elements at the first processor core; to calculate a first scale and a first zero point for the first group of 64 elements based on the first dynamic range; and to quantize the first group of 64 elements into eight-bit integer representation according to the first scale and the first zero point.

The system repeats these Blocks of the method S100 for each group of 64 elements: to load the group of 64 elements into local memory of a processor core of the processor; to calculate a dynamic range of the group of 64 elements at the first processor core; to calculate a scale (e.g., a scale characterized by a power of two) and a zero point for the group of 64 elements based on the dynamic range; and to quantize the group of 64 elements into an eight-bit integer representation according to the scale and the zero point in order to generate a first reduced-precision output activation.

The system then executes Blocks of the method S100 to pass the first reduced-precision output activation to an operation in the first layer (or another layer). Additionally or alternatively, the system can execute Blocks of the method S100 to dequantize groups of reduced-precision elements in the first reduced-precision output activation into a floating-point output activation based on scales and zero points associated with these groups.

The system repeats these Blocks of the method S100 for each layer in the set of layers. The system then executes Blocks of the method S100: to generate a set of output data (e.g., output tokens) based on final output activation(s) of a final layer; and to serve the set of output data to a user.

### 2.2 Variations

As described herein, the system executes Blocks of the method S100 to dynamically quantize output activations of a model—such as a large language model or a generative pre-trained transformer—from a floating-point representation into a reduced-precision representation during inference.

However, the system can similarly execute Blocks of the method S100 to dynamically quantize activations (e.g., output activations, input activations) of other models—such as a latent diffusion model, a convolutional neural network, etc.—from a floating-point representation into a reduced-precision representation during inference.

### 3. Terminology

Generally, an “activation” is referred to herein as an output of an operation (or a “node”) of a model (e.g., a neural network) according to an input.

Generally, a “tensor” is referred to herein as a data structure representing elements of data, such as an activation.

### 4. System

Generally, as shown in FIG. 1, the system can include or interface with a processor including: a set of processor cores (e.g., central processing unit cores, graphics processing unit cores, neural network processing units); a main memory (e.g., DDR SDRAM); and a shared memory (e.g., L2 memory) accessible to the set of processor cores. Each processor core, in the set of processor cores, can include a local memory characterized by a memory capacity (or a “memory size”) and/or a set of dimensions. More specifically, each processor core can include: a register file including a set of processor registers (e.g., scalar registers, vector registers); and L1 memory.

In one implementation, the system accesses a model (e.g., a neural network, a generative pre-trained transformer, a large language model, a latent diffusion model, a convolutional neural network) characterized by a set of layers including a set of operations (e.g., matrix multiplication operations, dot product operations, SoftMax function operations). The system: accesses a set of input data (e.g., an input prompt, an input token) from a user; and executes the model according to the set of input data via the processor (e.g., via the set of processor cores).

For example, the system executes a first operation in the set of operations via the processor to generate a first floating-point output activation representing a first output of the first operation. The first floating-point output activation is characterized by a first tensor including a first set of floating-point elements (e.g., the first set of floating-point elements characterized by a sixteen-bit floating-point representation).

In another implementation, during execution of the model at the processor, the system: detects a first group size (e.g., 64 elements) for the first operation; and segments the first floating-point output activation into a first set of subtensors. Each subtensor includes a subset of floating-point elements—in the first set of floating-point elements—characterized by a quantity of distinct elements (e.g., 64 floating-point elements) corresponding to the first group size.

For each subtensor in the first set of subtensors, the system: loads a subset of floating-point elements of the subtensor completely within local memory of a processor core in the set of processor cores; calculates a set of statistics (e.g., a minimum value, a maximum value, a range between the minimum value and the maximum value) based on the subset of floating-point elements; calculates a local scale and/or a local zero point for the subset of floating-point elements based on the set of statistics; and converts the subset of floating-point elements into a subset of reduced-precision elements—in a first set of reduced-precision elements—characterized by a reduced-precision (e.g., eight-bit integer, sixteen-bit integer) representation according to the local scale and/or the local zero point.

In this implementation, the system: generates a first reduced-precision output activation representing the first output of the first operation based on the first set of reduced-precision elements; and dispatches (or “passes”) the first reduced-precision output activation as an input for a second operation in the set of operations.

Therefore, the system can dynamically convert (or “quantize”) the first floating-point output activation into a first reduced-precision output activation—characterized by the first set of reduced-precision elements—representing the first output of the first operation in order to reduce power consumption and/or a memory footprint occupied by the model during execution.

Additionally, by segmenting the first set of floating-point elements—characterizing the first floating-point output activation—into groups of floating-point elements, the system can: calculate a local range and a local scale for each group of floating-point elements (rather than calculating a single range and a single scale for the first set of floating-point elements); and convert each group of floating-point elements into a group of reduced-precision elements characterized by the local scale in order to reduce accuracy loss during quantization, such as in response to elements in the first set of floating-point elements exhibiting relatively high variability from another.

The system can execute the foregoing methods and techniques for each operation in the set of operations.

Additionally, the system can: generate a set of output data (e.g., an output prompt, an output token) based on a final output activation(s) of a final operation in the set of operations; and serve the set of output data to the user.

### 5. Group Size and Data Representation Assignment

The method S100 includes, for each operation in the set of operations: detecting a representative operation type, in a set of operation types, characterizing the operation in Block S102; and deriving a group size and a reduced-precision representation for the operation based on the representative operation type in Block S104.

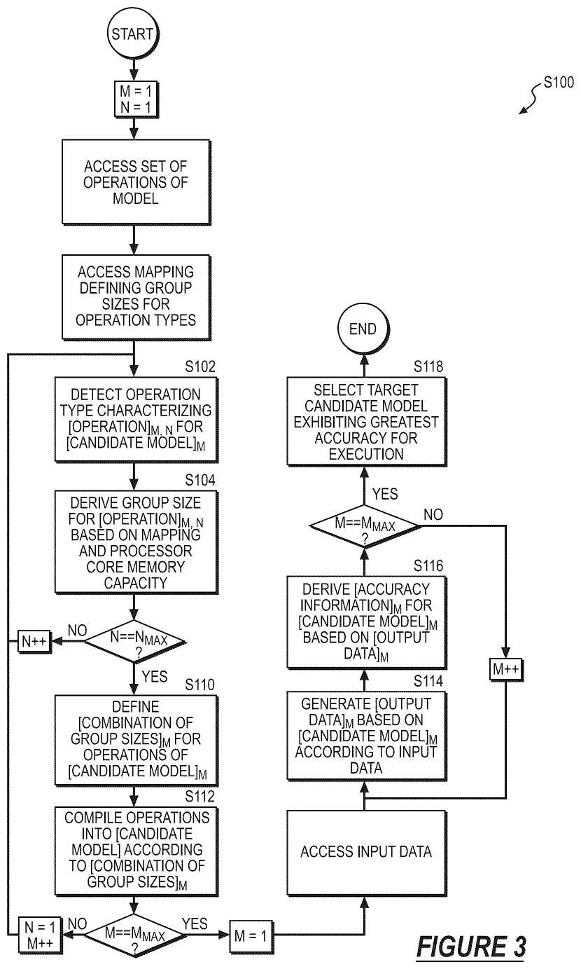

Generally—as shown in FIG. 3 and in Blocks S102 and S104—during a first time period (e.g., during compilation of a model, during a time period preceding runtime execution of the model), the system can access a model characterized by a set of layers including a set of operations. Each layer in the set of layers can include: a subset of operations in the set of operations; a set of weights; and/or a set of biases. For each operation in the set of operations, the system can derive a group size (e.g., 64 elements, 128 elements) and a data representation (e.g., a reduced-precision representation, eight-bit integer representation, sixteen-bit integer representation) for the operation, such as based on an operation type of the operation and/or a memory capacity of a processor core in the set of processor cores.

Therefore, by deriving a group size for an operation based on operation type and memory capacity of the processor core, the system can: store a group of elements characterized by the group size within a local memory (e.g., a processor register, L1 memory) of the processor core; and calculate a local scale for the group of elements within the local memory—rather than the shared memory of the processor, which operates slower than the local memory of the processor core—in order to increase execution speed (e.g., reduce completion time, increase token rate) of the model, to reduce overhead attributed to memory operations between the local memory and the shared memory, and to reduce power consumption.

### 5.1 First Operation

In one implementation, the system: accesses a first operation in a set of operations of a model; detects a first operation type, in a set of operation types, characterizing the first operation in Block S102; and derives a first group size—and a first reduced-precision representation—for the first operation based on the first operation type in Block S104.

More specifically, the system can generate (or access) a mapping defining a set of operation types. For each operation type in the set of operation types, the system can generate the mapping defining a group size and a reduced-precision representation for the operation type. The system can then: select a target operation in the set of operations; detect a representative operation type characterizing the target operation; and derive (or assign) a target group size—and a target reduced-precision representation—for the target operation based on the representative operation type and the mapping.

Additionally or alternatively, the system can: access a set of processor characteristics indicating a memory capacity of a processor core (e.g., memory capacity of a register file in the process core) in the set of processor cores; and derive the target group size and the target reduced-precision representation for the target operation based on the representative operation type and the memory capacity of the processor core. In particular, the system can validate that a group of elements, associated with the target operation and characterized by the target group size, corresponds to an amount of memory falling below the memory capacity of the processor core.

For example, the system can access the mapping defining: a first group size (e.g., 64 elements) assigned to operations characterized by a first operation type (e.g., matrix multiplication) in the set of operation types; and a first reduced-precision representation (e.g., eight-bit integer representation) assigned to operations characterized by the first operation type.

In this example, the system can: access a first operation in a set of operations of a model; detect the first operation type characterizing the first operation; access a set of processor characteristics indicating a memory capacity of a processor core in the set of processor cores, and derive (or assign) the first group size and the first reduced-precision representation for the first operation based on the first operation type, the mapping, and the memory capacity of the processor core.

### 5.2 Additional Operations

The system repeats the foregoing methods and techniques for each operation in the set of operations: to detect a representative operation type, in the set of operation types, characterizing the operation; and to derive a group size—and a reduced-precision representation—for the operation based on the representative operation type, the mapping, and/or the memory capacity of the processor core.

In one example, the system: accesses a second operation in the set of operations; detects a second operation type (e.g., SoftMax), in the set of operation types, characterizing the second operation; and derives a second group size (e.g., 1,024 elements)—and a second reduced-precision (e.g., eight-bit integer) representation—for the second operation based on the second operation type, the mapping, and/or the memory capacity of the processor core.

In another example, the system: accesses a third operation in the set of operations; detects a third operation type (e.g., accumulation), in the set of operation types, characterizing the second operation; and derives a third group size (e.g., 1,024 elements)—and a third reduced-precision (e.g., sixteen-bit integer) representation—for the second operation based on the third operation type, the mapping, and/or the memory capacity of the processor core.

In response to deriving a set of group sizes and a set of data representations for the set of operations, the system compiles the model according to the set of group sizes and the set of data representations for execution at the processor.

### 5.3 Variation: Inter-Operation Group Size Assignment

In one variation, the computer system can derive a group size and/or a reduced-precision representation for an operation based on another operation(s) (e.g., a preceding operation(s)).

In this variation, the system executes the foregoing methods and techniques: to access a subset of operations in the set of operations, such as a first operation and a second operation succeeding the first operation; to detect representative operation types of the subset of operations; and to derive group sizes and/or reduced-precision representations for an operation(s) (e.g., the first operation, the second operation) in the subset of operations based on the representative operation types of the subset of operations.

For example, the system can: access a subset (e.g., a contiguous series) of operations—in the set of operations—including a first operation, a second operation, and a third operation; detect a first operation type (e.g., matrix multiplication), in the set of operation types, characterizing the first operation; detect a second operation type (e.g., partial accumulator), in the set of operation types, characterizing the second operation; and detect a third operation type (e.g., final accumulator), in the set of operation types, characterizing the third operation. The first operation (e.g., a matrix multiplication operation) generates a block (or subtensor); the second operation (e.g., a partial accumulator operation) accumulates the block into a first result; and the third operation (e.g., a final accumulator operation) accumulates the first result (e.g., with results from other partial accumulator operations) into a second result.

In this example, the system can derive a group size and a reduced-precision representation for the third operation based on the first operation type, the second operation type, and/or the third operation type.

More specifically, the computer system can derive the group size and/or the reduced-precision representation for the third operation based on: the first result of the second operation (e.g., the partial accumulator operation) and/or the second result of the third operation (e.g., the final accumulator operation).

### 5.3 Experimental Group Size and Data Representation Assignment

Additionally or alternatively, the system can derive group sizes and/or reduced-precision representations for operations of the model based on a set of accuracy metrics, such as perplexity, massive multitask language understanding (or “MMLU”), and/or other metrics (e.g., zero-shot inference metrics) that evaluate a model, etc.

In one variation, the system executes the foregoing methods and techniques to derive a first combination of group sizes and a first combination of reduced-precision representations for the set of operations in Block S110.

For example, based on the first operation type characterizing the first operation and/or the memory capacity of the processor core, the system can: derive the first combination of group sizes including the first group size (e.g., 64 elements) for the first operation; and derive the first combination of reduced-precision representations including the first reduced-precision representation (e.g., eight-bit integer representation) for the first operation.

In this variation, the system: compiles the set of operations into a first candidate model, in a set of candidate models, according to the first combination of group sizes and the first combination of reduced-precision representations in Block S112; accesses a set of input data (e.g., an input prompt); generates a first set of output data based on the first candidate model according to the set of input data in Block S114; and derives (or accesses) a first set of accuracy information for the first candidate model based on the first set of output data and the set of accuracy metrics in Block S116. For example, the system can derive the first set of accuracy information including: a first perplexity score; a first MMLU score; etc.

The system repeats the foregoing methods and techniques for each candidate model in a set of candidate models: to derive a combination of group sizes and a combination of data representations for the set of operations; to compile the set of operations into a candidate model, in the set of candidate models, according to the combination of group sizes and the combination of reduced-precision representations; to generate a set of output data based on the candidate model according to the set of input data; and to derive (or access) a set of accuracy information for the candidate model based on the set of output data and the set of accuracy metrics.

In this variation, in Block S118, the system selects a target candidate model, in the set of candidate models, based on sets of accuracy information of the set of candidate models and/or memory capacity of a processor core in the set of processor cores.

In one example, the system: identifies a target candidate model exhibiting highest accuracy among the set of candidate models based on a representative set of accuracy information associated with the target candidate model; and selects the target candidate model—characterized by a target combination of group sizes and a target combination of data representations for the set of operations—for execution at the processor.

More specifically, in response to identification of the first candidate model as a target candidate model exhibiting highest accuracy among the set of candidate models based on the first set of accuracy information, the system can select the first candidate model as the model for execution at the set of processor cores.

Additionally or alternatively, the system: accesses a policy defining a threshold accuracy for execution of the model; and selects the target candidate model for execution at the processor in response to detection of the representative set of accuracy information—associated with the target candidate model—indicating an accuracy exceeding the threshold accuracy.

In another example, the system: accesses an objective function based on the set of accuracy metrics and a memory capacity of a processor core in the set of processor cores; and selects a target candidate model in the set of candidate models for execution at the processor based on the objective function and a target set of accuracy information associated with the target candidate model.

Therefore, the system can select the target candidate model - characterized by a target combination of group sizes and a target combination of data representations for the set of operations—that balances output accuracy with impact to memory footprint (e.g., maximizes output accuracy while minimizing memory footprint).

### 5.4 Weight Quantization

In another variation, the system accesses a model including a set of floating-point layers. Each floating-point layer in the set of floating-point layers includes a set of floating-point weights.

In this variation, the system: converts the set of floating-point weights into a set of reduced-precision (e.g., eight-bit, sixteen-bit) weights; and generates a quantized model based on the set of reduced-precision weights, such as described in U.S. patent application Ser. No. 17/112,889, filed on 04, Dec. 2020, which is incorporated in its entirety by this reference.

For example, during the first time period and for each floating-point layer in the set of floating-point layers, the system can convert the floating-point layer into a reduced-precision layer—in a set of reduced-precision layers—including a set of reduced-precision weights representing a set of floating-point weights of the floating-point layer.

### 6. Dynamic Output Activation Quantization

The method S100 includes, for a first operation in a set of operations of the model: accessing a first floating-point output activation representing a first output of the first operation and characterized by a first tensor including a first set of floating-point elements; in Block S120, detecting a first group size and a first reduced-precision representation assigned to the first operation in Block S122; and segmenting the first tensor into a first set of subtensors in Block S124. Each subtensor in the first set of subtensors: is characterized by a quantity of elements corresponding to the first group size; and includes a subset of floating-point elements in the first set of floating-point elements.

The method S100 includes, for each subtensor in the first set of subtensors, at a processor core in the set of processor cores: loading the subset of floating-point elements of the subtensor completely within local memory in the processor core in Block S130; calculating a set of statistics based on the subset of floating-point elements in the subtensor in Block S132; calculating a scale for the subset of floating-point elements based on the set of statistics in Block S134; and converting the subset of floating-point elements into a subset of reduced-precision elements, in a first set of reduced-precision elements, characterized by the first reduced-precision representation according to the scale in Block S136.

The method S100 includes: generating a first reduced-precision output activation in Block S140; and dispatching the first reduced-precision output activation as an input for a second operation in the set of operations in Block S142. The first reduced-precision output activation: represents the first output of the first operation; and is characterized by the first set of reduced-precision elements.

Generally—as shown in FIG. 3 and in Blocks S120, S122, S124, S130, S132, S134, S136, S140, and S142—the system can: during a second time period succeeding the first time period (e.g., during runtime execution of a model at the processor), access the model characterized by a set of layers including a set of operations; access a set of input data (e.g., an input prompt, an input token) from a user; and execute the model according to the set of input data via a processor including a set of processor cores.

More specifically, for each operation in the set of operations, the system can: access a floating-point output activation representing an output of the operation and characterized by a tensor including a set of floating-point elements; detect a group size and a reduced-precision representation assigned to the operation; segment the tensor into a set of subtensors based on the group size; calculate a dynamic range of the subset of floating-point elements; calculate a scale and a zero point for the subset of floating-point elements based on the dynamic range; and convert the subset of floating-point elements into a subset of reduced-precision elements characterized by the reduced-precision representation according to the scale and the zero point.

Therefore, the system can: store each subset of floating-point elements (completely) within local memory of a processor core; and calculate a scale and a zero point local to each subset of floating-point elements, thereby reducing completion time (e.g., by bypassing memory operations between local memory and shared memory) and/or reducing accuracy loss during quantization of floating-point elements to reduced-precision elements.

### 6.1 First Output Activation Quantization

In one implementation, the system generates a first floating-point output activation in response to execution of a first operation in the set of operations at the processor. The first floating-point output activation: represents a first output of the first operation; and is characterized by a first tensor including a first set of floating-point elements.

In this implementation, the system: accesses the first floating-point output activation in Block S120; detects a first group size and/or a first reduced-precision representation assigned to the first operation in Block S122; and segments the first floating-point output activation into a first set of subtensors in Block S124. Each subtensor in the first set of subtensors: is characterized by a quantity of elements corresponding to the first group size; and includes a subset of floating-point elements in the first set of floating-point elements.

For example, the system can segment the first floating-point output activation into the first set of subtensors including: a first subtensor including a first subset of floating-point elements in the first set of floating-point elements; and a second subtensor including a second subset of floating-point elements in the first set of floating-point elements.

For each subtensor in the first set of subtensors, the system: loads the subset of floating-point elements of the subtensor completely within local memory (e.g., a register file, L1 memory) in a processor core in the set of processor cores in Block S130; calculates a set of statistics (e.g., a minimum value, a maximum value, a dynamic range spanning the minimum value and the maximum value) based on the subset of floating-point elements in the subtensor in Block S132; calculates a local scale and a local zero point for the subset of floating-point elements based on the set of statistics in Block S134; and converts the subset of floating-point elements into a subset of reduced-precision elements, in a first set of reduced-precision elements, characterized by the first reduced-precision representation according to the local scale and the local zero point in Block S136.

### 6.1.1 First Subtensor

In another implementation, the system: accesses the first subtensor including the first subset of floating-point elements; and loads the first subtensor (completely) in a first local memory of the first processor core.

In this implementation, the system (e.g., the first processor core) calculates a first set of statistics based on the first subset of floating-point elements.

For example, the system can calculate the first set of statistics including: a first minimum value in the first subset of floating-point elements; a first maximum value in the first subset of floating-point elements; and/or a first range between the first minimum value and the first maximum value.

In another implementation, the system (e.g., the first processor core): calculates a first scale and a first zero point for the first subset of floating-point elements based on the first set of statistics; and converts the first subset of floating-point elements into a first subset of reduced-precision elements, in a first set of reduced-precision elements, characterized by the first reduced-precision representation according to the first scale and the first zero point.

More specifically, the system can: calculate the first scale characterized by a first integer power of two (e.g., a scale of 2ⁿ, where n is an integer); and convert the first subset of floating-point elements into the first subset of reduced-precision elements by executing bit shift operations on the first subset of floating-point elements according to the first integer power of two.

Therefore, by calculating the first scale characterized by an integer power of two, the system can convert the first subset of floating-point elements into the first subset of reduced-precision elements based on bit shift operations—rather than division operations—in order to simplify and/or accelerate computation for a resource-constrained device.

### 6.1.2 Additional Subtensors

The system repeats the foregoing methods and techniques for each subtensor in the first set of subtensors: to load a subset of floating-point elements of the subtensor completely within local memory of a processor core in the set of processor cores; to calculate a set of statistics based on the subset of floating-point elements in the subtensor; to calculate a local scale and a local zero point for the subset of floating-point elements based on the set of statistics; and to convert the subset of floating-point elements into a subset of reduced-precision elements, in the first set of reduced-precision elements, characterized by the first reduced-precision representation according to the local scale and the local zero point.

For example, the system can: access the second subtensor including the second subset of floating-point elements; and load the second subtensor (completely) in a second local memory of a second processor core in the set of processor cores.

In this example, the system (e.g., the second processor core) can: calculate a second set of statistics (e.g., a second minimum value, a second maximum value, a second range spanning the second minimum value and the second maximum value) based on the second subset of floating-point elements; calculate a second scale—different from the first scale and characterized by a second integer power of two—and a second zero point for the second subset of floating-point elements based on the second set of statistics; and convert the second subset of floating-point elements into a second subset of reduced-precision elements, in the first set of reduced-precision elements, characterized by the first reduced-precision representation according to the second scale and the second zero point, such as by executing bit shift operations on the second subset of floating-point elements according to the second integer power of two.

### 6.1.3 Reduced-precision Output Activation

In one implementation, the system: generates a first reduced-precision output activation—representing the first output of the first operation—characterized by the first set of reduced-precision elements in Block S140; and dispatches the first reduced-precision output activation as an input for a subsequent (e.g., a second) operation in the set of operations in Block S142.

### 6.2 Subsequent Output Activation Quantization

The system can repeat the foregoing methods and techniques for each operation in the set of operations: to access a floating-point output activation representing an output of the operation and characterized by a tensor including a set of floating-point elements; to detect a target group size and/or a target reduced-precision representation assigned to the operation; and to segment the tensor into a set of subtensors based on the target group size. Each subtensor in the set of subtensors: is characterized by a quantity of elements corresponding to the target group size; and includes a subset of floating-point elements in the set of floating-point elements.

For each subtensor in the set of subtensors, the system can execute the foregoing methods and techniques: to load the subset of floating-point elements of the subtensor completely within local memory of a processor core in the set of processor cores; to calculate a set of statistics based on the subset of floating-point elements in the subtensor; to calculate a local scale and a local zero point for the subset of floating-point elements based on the set of statistics; and to convert the subset of floating-point elements into a subset of reduced-precision elements, in a set of reduced-precision elements, characterized by the target reduced-precision representation according to the local scale and the local zero point.

Additionally, the system can: generate a set of output data (e.g., an output prompt, an output token) based on a final output activation(s) of a final operation in the set of operations; and serve the set of output data to the user.

### 6.3 Output Activation Dequantization

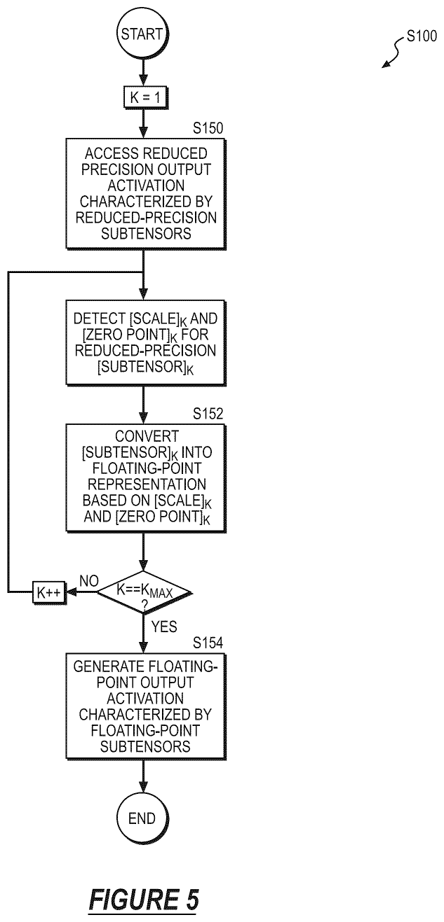

Generally, as shown in FIG. 5, the system can: access a reduced-precision output activation characterized by a set of reduced-precision elements; and convert the reduced-precision output activation into a floating-point output activation based on a set of scales and a set of zero points associated with the set of reduced-precision elements.

In one implementation, in Block S150, the system accesses a reduced-precision output activation (e.g., a tensor): representing an output of an operation in the set of operations; and characterized by a set of reduced-precision elements.

More specifically, the system can access the reduced-precision output activation characterized by the set of reduced-precision elements including subsets of reduced-precision elements (e.g., subtensors). Each subset of reduced-precision elements, in the set of reduced-precision elements, is characterized by a reduced-precision representation according to: a scale, such as a scale characterized by an integer power of two; and a zero point.

In this implementation, for each subset of reduced-precision elements in the set of reduced-precision elements, the system converts the subset of reduced-precision elements into a subset of dequantized floating-point elements, in a set of dequantized floating-point elements, based on the scale and the zero point in Block S152, such as by executing bit shift operations on the subset of reduced-precision elements according to the integer power of two.

For example, the system can access the reduced-precision output activation characterized by the set of reduced-precision elements including: a first subset of reduced-precision elements characterized by a first reduced-precision representation according to a first scale and a first zero point; and a second subset of reduced-precision elements characterized by the first reduced-precision representation according to a second scale—different from the first scale—and a second zero point.

In this example, the system: converts the first subset of reduced-precision elements into a first subset of dequantized floating-point elements, in a set of dequantized floating-point elements, based on the first scale and the first zero point; and converts the second subset of reduced-precision elements into a second subset of dequantized floating-point elements, in the set of dequantized floating-point elements, based on the second scale and the second zero point.

In another implementation, in Block S154, the system generates a dequantized (floating-point) output activation: representing the output of the operation; and characterized by the set of dequantized floating-point elements.

Therefore, the system can dynamically convert (or “dequantize”) a reduced-precision output activation into a floating-point output activation based on scales and zero points associated with subsets of reduced-precision elements characterizing the reduced-precision output activation.

Additionally, by characterizing a subset of reduced-precision elements based on a scale corresponding to a power of two, the system can convert the subset of reduced-precision elements into a subset of floating-point elements based on bit shift operations—rather than multiplication operations—in order to simplify and/or accelerate computation for a resource-constrained device.

### 7. Example: Large Language Model

In one example, the system: accesses a large language model including a set of operations; accesses a set of input data (e.g., an input prompt, an input token) from a user; and executes the large language model at a set of processor cores according to the set of input data.

In this example, for a first operation in the set of operations of the large language model, the system: accesses a first floating-point output activation—representing a first output of the first operation—characterized by a first tensor including a first set of floating-point elements; and derives a first group size and a first reduced-precision representation for the first operation, such as based on a memory capacity of a processor core in the set of processor cores and/or metadata defining the first group size and the first reduced-precision representation assigned to the first operation.

More specifically, the system can: access the metadata defining a first maximum group size for the first operation; detect the memory capacity of the processor core; and (dynamically) derive the first group size—corresponding to or falling below the first maximum group size—for the first operation based on the memory capacity of the processor core.

In this example, the system segments the first tensor into a first set of subtensors based on the first group size. Each subtensor in the first set of subtensors: is characterized by a quantity of elements corresponding to the first group size; and includes a subset of floating-point elements in the first set of floating-point elements.

For each subtensor in the first set of subtensors, the system: loads the subset of floating-point elements of the subtensor completely within local memory in the processor core; calculates a dynamic range of the subset of floating-point elements; calculates a local scale and a local zero point for the subset of floating-point elements based on the dynamic range; and converts the subset of floating-point elements into a subset of reduced-precision elements, in a first set of reduced-precision elements, characterized by a fixed-point representation according to the local scale and the local zero point.

In this example, the system: generates a first reduced-precision output activation—representing the first output of the first operation—characterized by the first set of reduced-precision elements; and dispatches the first reduced-precision output activation as an input for a second operation in the set of operations.

The system repeats the foregoing methods and techniques for each operation in the set of operations of the large language model.

In this example, the system then: generates a set of output data (e.g., an output prompt, an output token) based on a final output activation(s) of a final operation in the set of operations; and serves the set of output data to the user.

### 8. Disclaimers

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for dynamic quantization of a model comprising, during execution of the model at a set of processor cores:
for a first operation in a set of operations of the model:
accessing a first floating-point output activation:
representing a first output of the first operation; and
characterized by a first tensor comprising a first set of floating-point elements;
detecting a first group size and a first reduced-precision representation assigned to the first operation; and
segmenting the first tensor into a first set of subtensors comprising a first subtensor, each subtensor in the first set of subtensors characterized by a quantity of elements corresponding to the first group size, the first subtensor comprising a first subset of floating-point elements in the first set of floating-point elements;
by a first processor core in the set of processor cores:
calculating a first set of statistics based on the first subset of floating-point elements;
calculating a first scale for the first subset of floating-point elements based on the first set of statistics; and
converting the first subset of floating-point elements into a first subset of reduced-precision elements, in a first set of reduced-precision elements, characterized by the first reduced-precision representation according to the first scale; and
generating a first reduced-precision output activation representing the first output of the first operation based on the first set of reduced-precision elements.

2. The method of claim 1:
wherein segmenting the first tensor into the first set of subtensors comprises segmenting the first tensor into the first set of subtensors comprising a second subtensor comprising a second subset of floating-point elements in the first set of floating-point elements;
further comprising, by a second processor core in the set of processor cores:
calculating a second set of statistics based on the second subset of floating-point elements;
calculating a second scale for the second subset of floating-point elements based on the second set of statistics, the second scale different from the first scale; and
converting the second subset of floating-point elements into a second subset of reduced-precision elements, in the first set of reduced-precision elements, characterized by the first reduced-precision representation according to the second scale; and
wherein generating the first reduced-precision output activation comprises generating the first reduced-precision output activation:
representing the first output of the first operation; and
characterized by the first set of reduced-precision elements.

3. The method of claim 1:
wherein detecting the first group size and the first reduced-precision representation assigned to the first operation comprises detecting the first reduced-precision representation characterized by an eight-bit integer representation;
wherein calculating the first scale for the first subset of floating-point elements comprises calculating the first scale and a first zero point for the first subset of floating-point elements based on the first set of statistics; and
wherein converting the first subset of floating-point elements into the first subset of reduced-precision elements comprises converting the first subset of floating-point elements into the first subset of reduced-precision elements characterized by the eight-bit integer representation according to:
the first scale; and
the first zero point.

4. The method of claim 1, wherein calculating the first set of statistics comprises:
loading the first subtensor in a first local memory of the first processor core; and
calculating the first set of statistics based on the first subset of floating-point elements of the first subtensor, the first set of statistics comprising:
a first minimum value in the first subset of floating-point elements;
a first maximum value in the first subset of floating-point elements; and
a first range between the first minimum value and the first maximum value.

5. The method of claim 4, wherein loading the first subtensor in the first local memory comprises loading the first subtensor completely within the first local memory comprising a first register file of the first processor core.

6. The method of claim 1, wherein calculating the first scale for the first subset of floating-point elements comprises calculating the first scale for the first subset of floating-point elements based on the first set of statistics, the first scale characterized by a first integer power of two.

7. The method of claim 6, wherein converting the first subset of floating-point elements into the first subset of reduced-precision elements comprises converting the first subset of floating-point elements into the first subset of reduced-precision elements by executing bit shift operations on the first subset of floating-point elements according to the first integer power of two.

8. The method of claim 1, further comprising, during a time period preceding execution of the model at the set of processor cores:
detecting a first operation type, in a set of operation types, characterizing the first operation; and
deriving the first group size and the first reduced-precision representation for the first operation based on the first operation type.

9. The method of claim 8, wherein deriving the first group size and the first reduced-precision representation for the first operation comprises:
accessing a mapping defining:
the first group size assigned to operations characterized by the first operation type; and
the first reduced-precision representation assigned to operations characterized by the first operation type; and
deriving the first group size and the first reduced-precision representation for the first operation based on the first operation type and the mapping.

10. The method of claim 8, wherein deriving the first group size and
the first reduced-precision representation for the first operation comprises:
accessing a set of processor characteristics indicating a memory capacity of a processor core in the set of processor cores; and
deriving the first group size and the first reduced-precision representation for the first operation based on the first operation type and the memory capacity of the processor core.

11. The method of claim 8:
wherein accessing the model comprises accessing the model comprising a second operation, in the set of operations, preceding the first operation;
further comprising detecting a second operation type, in the set of operation types, characterizing the second operation; and
wherein deriving the first group size and the first reduced-precision representation for the first operation comprises deriving the first group size and the first reduced-precision representation for the first operation based on:
the first operation type; and
the second operation type.

12. The method of claim 1, further comprising, during a time period preceding execution of the model at the set of processor cores:
deriving a first combination of group sizes and a first combination of reduced-precision representations to the set of operations, the first combination of group sizes comprising the first group size for the first operation, the first combination of reduced-precision representations comprising the first reduced-precision representation for the first operation;
compiling the set of operations into a first candidate model, in a set of candidate models, according to the first combination of group sizes and the first combination of reduced-precision representations;
generating a first set of output data based on the first candidate model according to a set of input data;
deriving a first set of accuracy information for the first candidate model based on the set of output data; and
in response to identification of the first candidate model as a target candidate model exhibiting highest accuracy among the set of candidate models based on the first set of accuracy information, selecting the first candidate model as the model for execution at the set of processor cores.

13. The method of claim 12:
wherein assigning the first combination of group sizes and the first combination of reduced-precision representations to the set of operations comprises:
accessing a set of processor characteristics indicating a memory capacity of a processor core in the set of processor cores; and
deriving the first combination of group sizes and the first combination of reduced-precision representations to the set of operations based on the memory capacity of the processor core.

14. The method of claim 1, further comprising:
accessing a second reduced-precision output activation:
representing a second output of a second operation in the set of operations; and
characterized by a second set of reduced-precision elements comprising:
a second subset of reduced-precision elements characterized by a second reduced-precision representation according to a second scale; and
a third subset of reduced-precision elements characterized by the second reduced-precision representation according to a third scale different from the second scale; and
further comprising:
converting the second subset of reduced-precision elements into a first subset of dequantized floating-point elements, in a first set of dequantized floating-point elements, based on the second scale;
converting the third subset of reduced-precision elements into a second subset of dequantized floating-point elements, in the first set of dequantized floating-point elements, based on the third scale; and
generating a first dequantized output activation:
representing the second output of the second operation; and
characterized by the first set of dequantized floating-point elements.

15. The method of claim 14, wherein converting the second subset of reduced-precision elements into the first subset of dequantized floating-point elements comprises:
detecting the second scale characterized by an integer power of two; and
converting the second subset of reduced-precision elements into the first subset of dequantized floating-point elements by executing bit shift operations on the second subset of reduced-precision elements according to the integer power of two.

16. A method for dynamic quantization of a model comprising, during execution of the model at a set of processor cores:
for a first operation in a set of operations of the model:
accessing a first floating-point output activation:
representing a first output of the first operation; and
characterized by a first tensor comprising a first set of floating-point elements;
detecting a first group size and a first reduced-precision representation assigned to the first operation; and
segmenting the first tensor into a first set of subtensors, each subtensor in the first set of subtensors:
characterized by a quantity of elements corresponding to the first group size; and
comprising a subset of floating-point elements in the first set of floating-point elements;
for each subtensor in the first set of subtensors, at a processor core in the set of processor cores:
loading the subset of floating-point elements of the subtensor completely within local memory in the processor core;
calculating a set of statistics based on the subset of floating-point elements in the subtensor;
calculating a scale for the subset of floating-point elements based on the set of statistics; and
converting the subset of floating-point elements into a subset of reduced-precision elements, in a first set of reduced-precision elements, characterized by the first reduced-precision representation according to the scale; and
generating a first reduced-precision output activation:
representing the first output of the first operation; and
characterized by the first set of reduced-precision elements.

17. The method of claim 16, wherein calculating the set of statistics, calculating the scale, and converting the subset of floating-point elements into the subset of reduced-precision elements for each subtensor in the first set of subtensors comprises:
calculating a dynamic range of the subset of floating-point elements in the subtensor;
calculating a local scale and a local zero point for the subset of floating-point elements based on the dynamic range of the subset of floating-point elements; and
converting the subset of floating-point elements into the subset of reduced-precision elements characterized by the first reduced-precision representation according to:
the local scale; and
the local zero point.

18. The method of claim 16, wherein calculating the scale and converting the subset of floating-point elements into the subset of reduced-precision elements for each subtensor in the first set of subtensors comprises:
calculating the scale for the subset of floating-point elements based on the set of statistics, the scale characterized by an integer power of two; and
converting the subset of floating-point elements into the subset of reduced-precision elements by executing bit shift operations on the subset of floating-point elements according to the integer power of two.

19. The method of claim 16, further comprising, for each operation in the set of operations:
detecting a representative operation type, in a set of operation types, characterizing the operation; and
deriving a group size and a reduced-precision representation for the operation based on the representative operation type.

20. A method for dynamic quantization of a large language model comprising, during execution of the large language model at a set of processor cores:
for a first operation in a set of operations of the large language model:
accessing a first floating-point output activation:
representing a first output of the first operation; and
characterized by a first tensor comprising a first set of floating-point elements; and
segmenting the first tensor into a first set of subtensors based on a first group size assigned to the first operation, each subtensor in the first set of subtensors:
characterized by a quantity of elements corresponding to the first group size; and
comprising a subset of floating-point elements in the first set of floating-point elements;
for each subtensor in the first set of subtensors, at a processor core in the set of processor cores:
loading the subset of floating-point elements of the subtensor completely within local memory in the processor core;
calculating a dynamic range of the subset of floating-point elements;
calculating a local scale and a local zero point for the subset of floating-point elements based on the dynamic range; and
converting the subset of floating-point elements into a subset of reduced-precision elements, in a first set of reduced-precision elements, characterized by a fixed-point representation according to the local scale and the local zero point;
generating a first reduced-precision output activation:
representing the first output of the first operation; and
characterized by the first set of reduced-precision elements; and
dispatching the first reduced-precision output activation as an input for a second operation in the set of operations.
